(19) United States
(12) Patent Application Publication
(10) Pub. No.: US 2006/0092982 A1
(43) Pub. Date: May 4, 2006

(54) Methods for media file recording, and recovery after power failure, and related devices

(75) Inventor: Shih-Chang Hu, Hsinchu County (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Incorporation

(21) Appl. No.: 10/976,982

(22) Filed: Oct. 29, 2004

(51) Int. Cl. H04H 1/04

(52) U.S. Cl. 370/487

(57) ABSTRACT

A method for providing media files. A video bitstream file, a video meta file, and an audio bitstream file are first runtime generated during recording. After the recording is suspended, an audio header file is generated corresponding to the audio bitstream file, and a video header file is generated corresponding to the video meta file. The audio header file and the video header file are merged into an AV header file, and the video bitstream file and the audio bitstream file are merged into an AV bitstream file. The AV bitstream file and the AV header file are further merged into a media file.

### BACKGROUND

The present disclosure relates generally to providing media files and, in particular, to the recording of such files, and recovery thereto from power failure.

In recent years, the popularization of optical recording devices such as DV (Digital Video) camcorders, VDRs (Video Disc Recorders), and portable phones with camera capability has made common use of digitized video data feasible. The digitized video data can be edited easily, and stored conveniently and securely.

The digitized video data, such as .mp4 and .3gp files, can be decoded and played back. Files comprise necessary information required for play back, such as bitstream length per frame, position of bitstream for each frame in video file, and others. Conventionally, the information is runtime recorded and merged into a media file. “Runtime” refers to the period during which the device is recording. The information, however, is complex and requires extensive use of system resources for AV (Audio and Video) integration. Additionally, the pre-stored information can be lost if recording devices experience power failure during recording. Conventionally, there is no mechanism to recover the recorded data after power failure, and the recorded data can be completely lost. The lack of media file recovery mechanism is a major defect of recording devices, and obstructs the development thereto.

### SUMMARY

Methods for providing media files, and related devices, are provided. In an exemplary embodiment of such a method, a video bitstream file, a video meta file, and an audio bitstream file are runtime generated during recording. A media file is then generated after recording has stopped, e.g., has been suspended or is completed.

An exemplary embodiment of a device comprises a storage device and a processing unit. The processing unit is operative to determine whether at least a video bitstream file and a video meta file exist in the storage device, determine whether the file sizes of the video bitstream file and the video meta file conform to the file sizes originally recorded if the video bitstream file and the video meta file exist, determine whether the video bitstream file and the video meta file have sufficient information to generate a media file if the file sizes conform, and generate the media file corresponding to the video bitstream file and the video meta file.

### DESCRIPTION OF THE DRAWINGS

Methods for providing media files, and related devices will become more fully understood by referring to the following detailed description with reference to the accompanying drawings, wherein:

FIG. 1 is a schematic diagram illustrating the architecture of an embodiment of a device for providing media files;

FIG. 2 is a flowchart showing an embodiment of a method for providing media files;

FIG. 3 is a schematic diagram illustrating an embodiment of a method for media file generation;

FIG. 4 is a flowchart showing an embodiment of a method for media file recovery;

FIG. 5a˜5c are flowcharts showing an embodiment of a method for checking files;

FIG. 6 is a flowchart showing an embodiment of a method for determining whether file information is sufficient to generate a media file;

FIG. 7 is a flowchart showing an embodiment of a method for merging files;

FIG. 8 is a flowchart showing an embodiment of a method for video header file generation; and

FIG. 9 is a flowchart showing an embodiment of a method for audio header file generation.

### DETAILED DESCRIPTION

Methods for providing media files, and related devices are provided. In this regard, exemplary embodiments of methods and devices will be described that perform various functions, such as recording and recovery of media files. In some embodiments, a media file is generated in response to the suspension of recording of various files. These files can include a video bitstream file, a video meta file, and an audio bitstream, all of which typically are runtime generated during recording.

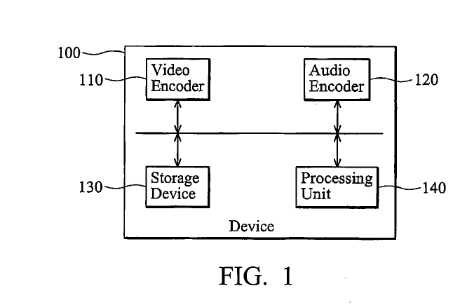

With reference to the figures, FIG. 1 is a schematic diagram illustrating the architecture of an embodiment of a device for recording media file. In this embodiment, the device is a DV camcorder, however, other embodiments can be configured as a VDR, a portable phone with camera capability, and others.

The device 100 comprises a video encoder 110, an audio encoder 120, a storage device 130, such as a hard disk or a memory card, and a processing unit 140. The device 100 operates using recording and generation stages. During the recording stage, the video encoder 110 runtime generates a video bitstream file and a video meta file, and the audio encoder 120 runtime generates an audio bitstream file. The video bitstream file comprises a video frame bitstream. The audio bitstream file comprises an audio bitstream. The video meta file comprises video type, an average frame rate, a video time scale, a position recoding the bitstream size in a video file, VOS (Visual Object Sequence) information, a frame time stamp per video frame, a frame length per video frame, and/or others.

The generated files can be stored in the storage device 130. It should be understood that these files can be temporarily stored in a RAM (not shown in FIG. 1) of the device 100, and the temporary files can be automatically updated to the storage device 130 if the total write data exceeds a predetermined threshold, e.g. 2 k bytes, or in every predetermined period. It should also be understood that the three files, i.e., the video bitstream file, the video meta file and the audio bitstream file, cannot be played by a media player without media file generation.

During the generation stage, the processing unit 140 automatically generates a media file corresponding to the video bitstream file, the video meta file, and the audio bitstream file. Typically, the generation stage occurs after the recording stage, e.g. after the recording is suspended. It should be understood that the device, in some embodiments, may further comprise a media player for decoding and playing the media file.

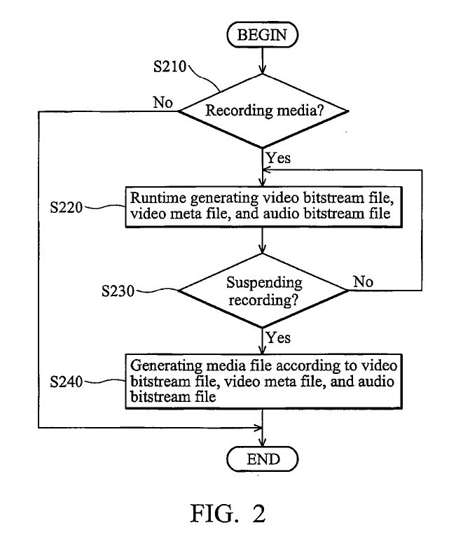

FIG. 2 is a flowchart showing an embodiment of a method for media file recording, such as may be implemented by device 100 of FIG. 1, for example. The method for media file recording has recording and generation stages. Specifically, if the device 100 begins recording of media (Yes in step S210), the device 100 enters the recording stage. In step S220, the video encoder 110 runtime generates a video bitstream file and a video meta file, and the audio encoder 120 runtime generates an audio bitstream file. The files can be stored to the storage device 130. Then, in step S230, it is determined whether the recording is suspended. If not, the procedure returns to step S220. Similarly, the files can be temporarily stored in the RAM of the device 100, and then automatically updated to the storage device 130. If so, the device 100 enters the generation stage. In step S240, the processing unit 140 begins to generate a media file corresponding to the video bitstream file, the video meta file, and the audio bitstream file.

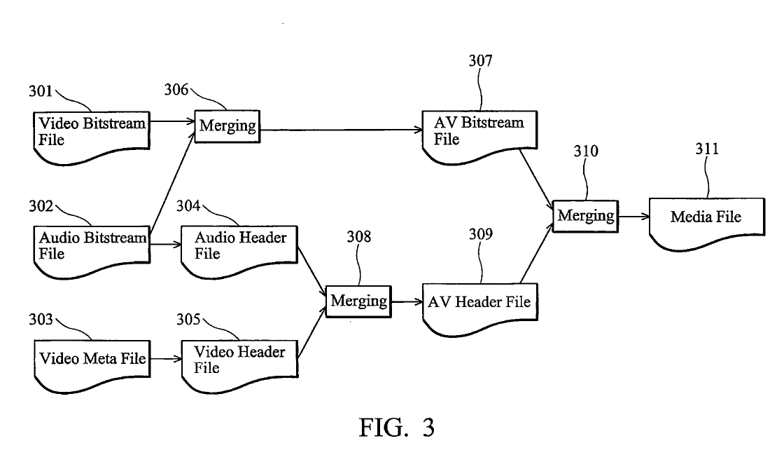

FIG. 3 is a schematic diagram illustrating an embodiment of a method for media file generation. In particular, an audio header file 304 is generated according to the audio bitstream file 302, and the content of the audio header file 304 is based on the definitions of a media file specification. Specifically, an intermediate audio meta file (not shown in FIG. 3) is generated using the audio bitstream file 302, and is used to generate the audio header file 304. Necessary data, such as frame length and duration, can be directly obtained and calculated from the audio bitstream file 302.

A video header file 305 is generated according to the video meta file 303, and the content of the video header file 305 is based on the definitions of the media file specification. The audio header file 304 and the video header file 305 are merged (308) into an AV header file 309.

Additionally, the video bitstream file 301 and the audio bitstream file 302 are merged (306) into an AV bitstream file 307. The AV bitstream file 307 and the AV header file 309 are merged (310) into a media file 311.

In the embodiment of FIG. 3, two merging methods are used, i.e. normal merging and pseudo merging. In normal merging, a source file, e.g. video header file 305, is stored into a buffer (not shown), and the source file is added to a destination file, e.g. audio header file 304, via the buffer. In pseudo merging, two files are linked directly without buffering. This can be accomplished by deleting the directory entry of the second file. The size of the first file is then calculated and updated. Since the file size corresponds to the size of cluster units of the storage device 130, the size of the first file typically requires rounding up for cluster alignment. The total size is (((size of first file+cluster size−1)/cluster size)*cluster size)+(size of second file). Finally, the EOC (End Of Chain) of the first file is marked as the first cluster of the second file. It is understood that details of pseudo merging appear in Taiwan patent application no. 093123029, filed in Jul. 30, 2004.

In the exemplary embodiment of FIG. 3, merging 308 is a normal merging process, and merging 306 and merging 310 are pseudo merging processes for increasing merging efficiency and conserving system resources. It should be understood that if no audio is recorded, the video bitstream file 301 and the video header file 305 can be directly merged into the media file.

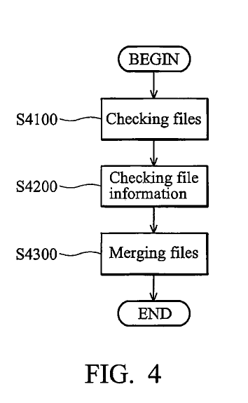

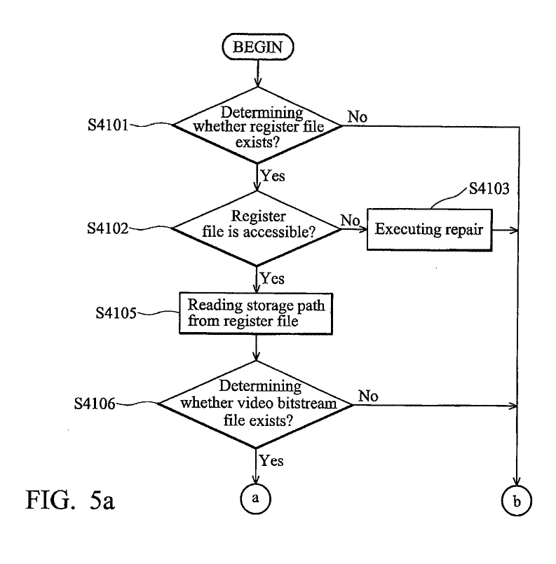

FIG. 4 is a flowchart showing an embodiment of a method for media file recovery. As shown in FIG. 4, three stages are employed in this embodiment for media file recovery. First, in step S4100, necessary files are checked to ensure that these files exist, and that these files are accessible. In step S4200, file information is checked to ensure existing files are sufficient to generate a media file. Finally, in step S4300, existing files are merged into the media file.

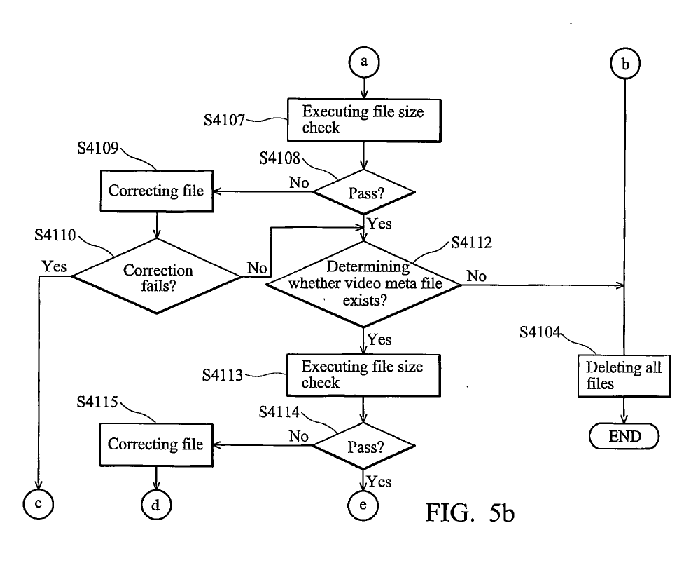

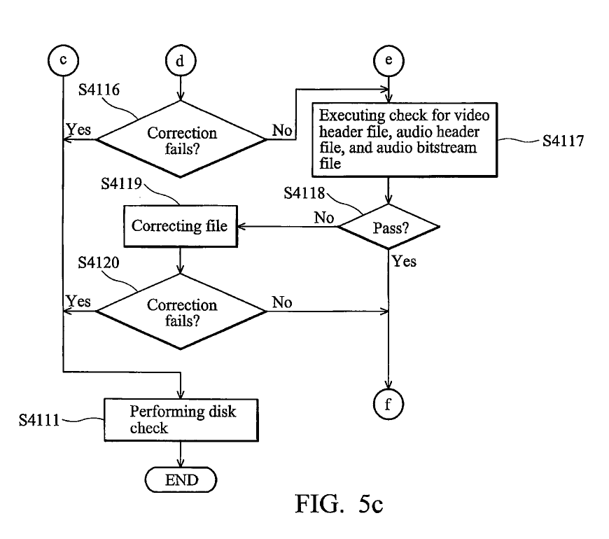

FIGS. 5a˜5c are flowcharts showing an embodiment of a method for checking files. First, in step S4101, it is determined whether a register file, such as an .INI file that records storage paths for necessary files, exists in the storage device 130. If so, the procedure proceeds to step S4102. If the register file does not exist, in step S4104 (FIG. 5b), all temporary files (video bitstream file, video meta file, and audio bitstream file) in the storage device 130 are deleted. If the register file exists, in step S4102, it is determined whether the register file is accessible (open/read/write). If not, in step S4103, a repair is executed for the register file, thus ensuring the file can be accessible next time. Afterward, in step S4104, all temporary files are deleted. If the register file is accessible, in step S4105, the storage paths for necessary files are read. The necessary files are stored, such as in the storage device 130, based on the storage paths.

In step S4106, it is determined whether a video bitstream file exists. If not, the procedure proceeds to step S4104. If so, in step S4107, a check is executed for the video bitstream file. It should be understood that the file is checked to determine whether the size thereof conforms to that recorded in a file system (not shown) that manages files in the storage device 130. If the file size conforms (check passes), the procedure proceeds to step S4112. If the file size does not conform (No in step S4108), in step S4109, the file or the size recorded in the file system is corrected. For example, the actual size of the file can be determined, and the file size can be updated by the determined size. As another example, the file can be trimmed based on the size recorded in the file system.

If the correction fails (Yes in step S4110), in step S4111, disk check (chkdsk) is performed. If the correction is successful (No in step S4110), in step S4112, it is determined whether a video meta file exists. If not, the procedure proceeds to step S4104. If so, in step S4113, a check is executed for the video meta file. If the file size conforms, the procedure proceeds to step S4117. If the file size does not conform (No in step S4114), in step S4115, the file or the size recorded in the file system is corrected. If the correction fails (Yes in step S4116), the procedure proceeds to step S4111. If the correction is successful (No in step S4116), in step S4117, it is determined whether a video header file, an audio header file, or an audio bitstream file exists, such as in the storage device 130, and whether the sizes of the existing files conform. If the file sizes conform (Yes in step S4118), the procedure proceeds to next stage (S4200). Similarly, if the size of any existing file does not conform (No in step S4118), in step S4119, a correction is made thereto. If the correction fails (Yes in step S4120), the procedure proceeds to step S4111. If the correction is successful (No in step S4120), the procedure proceeds to next stage (S4200). There, it is assumed that a media file comprises video related files, and optional audio related files. If no video related files exist in the media file, the recovery process terminates. If audio related files do not exist, the recovery process continues.

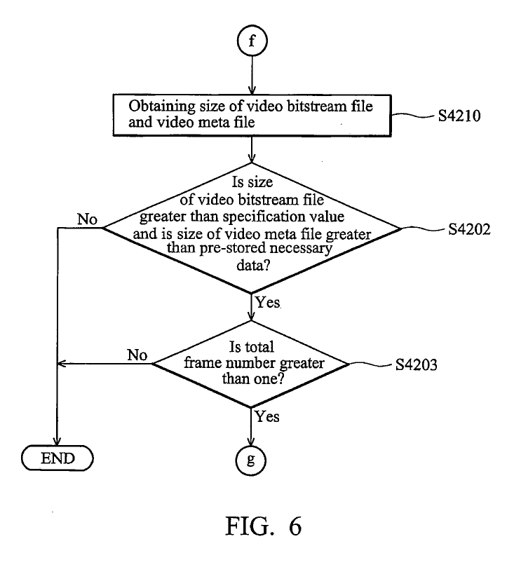

FIG. 6 is a flowchart showing an embodiment of a method for determining whether file information is sufficient to generate a med7ia file. First, in step S4201, the sizes of the video bitstream file and the video meta file are obtained. In step S4202, it is determined whether the size of the video bitstream file exceeds a specification-defined value, and whether the size of the video meta file exceeds pre-stored necessary data. If not (No in step S4202), the procedure terminates. If so, in step S4203, it is determined whether the total video frame number exceeds one. If not (No in step S4203), the procedure terminates. If so, the procedure proceeds to next stage (S4300).

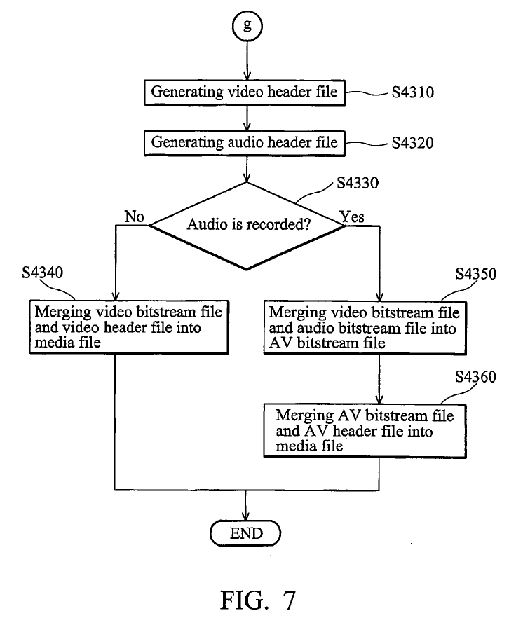

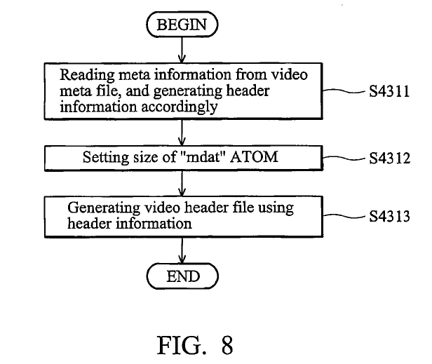

FIG. 7 is a flowchart showing an embodiment of a method for merging files. First, in step S4310, a video header file is generated. FIG. 8 is a flowchart showing an embodiment of a method for video header file generation. In step S4311, meta information is read from the video meta file, and header information is generated accordingly. The meta information comprises video type, an average frame rate, a video time scale, a position of size that recode the bitstream size in a video file, VOS information, a frame time stamp per video frame, a frame length per video frame, and/or others. Then, in step S4312, the size of “mdat” ATOM (audio/video bitstream) is set. It should be understood that the terms “mdat” and “ATOM” refer to MPEG4 media specification, and details are omitted here. If an audio bitstream file does not exist and a video header file already exists, the size of “mdat” ATOM is first obtained, and the total number of frames in the video meta file is re-calculated. Then, the size of media file after pseudo merging is predicted as video file size=((video file size+cluster size−1)/cluster size)* cluster size), and the size of “mdat” ATOM is set as video file size−video mdat size. Finally, in step S4313, a video header file is generated using the header information.

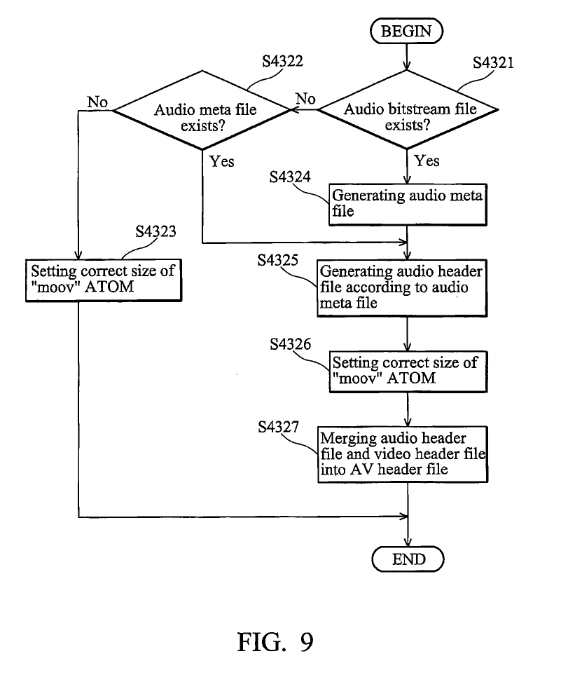

In step S4320 of FIG. 7, an audio header file is generated. FIG. 9 is a flowchart showing an embodiment of a method for audio header file generation. First, it is determined whether audio is recorded by determining whether an audio bitstream file or an audio meta file exists (steps S4321 and S4322). If none of the files exist (No in step S4321 and No in step S4322), in step S4323, the correct size of “moov” ATOM is set, and the procedure terminates. The term “moov” refers to MPEG4 media specification, and details are omitted here. If the audio bitstream file exists, in step S4324, an audio meta file is generated corresponding to the audio bitstream file, and the procedure proceeds to step S4325. It should be noted that the audio meta file includes the necessary information, such as frame length, which is used for generating the audio header file. If the audio bitstream file does not exist and the audio meta file exists, the procedure proceeds to step S4325. In step S4325, an audio header file is generated according to the audio meta file, and in step S4326, the correct size of “moov” ATOM is set. Finally, in step S4327, the audio header file and the video header file are merged into an AV header file. Referring to FIG. 7 again, if audio is not recorded (No in step S4330), in step S4340, the video bitstream file and the video header file are directly merged into a media file. If audio is recorded (Yes in step S4330), in step S4350, the video bitstream file and the audio bitstream file are merged into an AV bitstream file, and in step S4360, the AV bitstream file and the AV header file are merged into a media file.

It should be understood that if recording devices experience power failure during the recording or generation (merging) stage, an embodiment of a method for media file recovery can check whether the video bitstream file, the audio bitstream file, the video meta file, the audio meta file, the audio header file, the video header file, and the AV header file exist to determine the merging progress. To start the merging progress, the three essential files, i.e. video bitstream file, audio bitstream file, and video meta file, must exit. When power failure occurs, some files may disappear, and the different merging progress should be executed for recovery. For example, if power failure occurs during the pseudo-merge procedure for AV bitstream file, the audio bitstream file will disappear and the audio meta file will exist because the audio bitstream file has been merged to the AV bitstream file and the audio meta file not yet. Therefore, the method according to the present invention is capable of checking which files exist and then determining in which stage of the merging procedure the power failure occurs. Based on the determination, the following merging procedure is executed for the recovery.

Methods for providing media files, or certain aspects or portions thereof, may take the form of program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiments, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

1. A method for providing a media file, comprising:
runtime generating a video bitstream file, a video meta file, and an audio bitstream file during recording; and
generating the media file corresponding to the video bitstream file, the video meta file, and the audio bitstream file after the recording is stopped.

2. The method of claim 1 further comprising:
generating an audio header file corresponding to the audio bitstream file;
generating a video header file corresponding to the video meta file;
merging the video bitstream file and the audio bitstream file into an AV bitstream file;
merging the audio header file and the video header file into an AV header file; and
merging the AV bitstream file and the AV header file into the media file.

3. The method of claim 2 further comprising generating at least one of the audio header file and the video header file according to the definitions of a media file specification.

4. The method of claim 1 further comprising:
generating a video header file corresponding to the video meta file;
determining whether audio is recorded corresponding to the audio bitstream file; and
merging the video bitstream file and the video header file into the media file if audio is not recorded.

5. The method of claim 4 further comprising generating the video header file according to the definitions of a media file specification.

6. The method of claim 1 further comprising generating the video meta file by recording a video type, an average frame rate, a video time scale, a position recoding the bitstream size in a video file, VOS (Visual Object Sequence) information, a frame time stamp per video frame, and a frame length per video frame therein.

7. A method for providing media files, comprising:
determining whether at least a video bitstream file and a video meta file exist in a storage device;
determining whether the file sizes of the video bitstream file and the video meta file conform to the file sizes originally recorded if the video bitstream file and the video meta file exist;
determining whether the video bitstream file and the video meta file have sufficient information to generate a media file if the file sizes conform; and
generating the media file corresponding to the video bitstream file and the video meta file.

8. The method of claim 7 further comprising correcting the video bitstream file or the video meta file if the file sizes do not conform.

9. The method of claim 8 further comprising performing disk check if the correction for the video bitstream file or the video meta file fails.

10. The method of claim 7 further comprising:
determining whether a register file recording storage paths for the video bitstream file and the video meta file exists; and
deleting all files from the storage device if the register file does not exist.

11. The method of claim 7 further comprising determining whether a video header file, an audio header file, or an audio bitstream file exists in the storage device, and determining whether the file size of any existing file conforms.

12. The method of claim 7 further comprising determining whether the video bitstream file and the video meta file have sufficient information to generate the media file by determining whether the size of the video bitstream file exceeds a specification defined value, and whether the size of the video meta file exceeds pre-stored necessary data.

13. The method of claim 7 further comprising determining whether the video bitstream file and the video meta file have sufficient information to generate the media file by determining whether the total video frame number exceeds one.

14. The method of claim 7 further comprising:
generating a video header file corresponding to the video meta file; and
merging the video bitstream file and the video header file into the media file.

15. The method of claim 12 further comprising:
generating a video header file corresponding to the video meta file;
generating an audio header file corresponding to the audio bitstream file if the audio bitstream file exists;
merging the video bitstream file and the audio bitstream file into an AV bitstream file;
merging the audio header file and the video header file into an AV header file; and
merging the AV bitstream file and the AV header file into the media file.

16. The method of claim 15 further comprising generating the audio header file or the video header file according to the definitions of a media file specification.

17. The method of claim 16 further comprising generating the video header file by transforming a video type, an average frame rate, a video time scale, a position recoding the bitstream size in a video file, VOS (Visual Object Sequence) information, a frame time stamp per video frame, and a frame length per video frame recorded in the video meta file to a format of the media file specification.

18. A method for providing media files, comprising:
determining whether at least a video bitstream file and a video meta file exist in a storage device; and
generating the media file corresponding to the video bitstream file and the video meta file.

19. The method of claim 18 further comprising determining whether an audio bitstream file exists in the storage device, and generating the media file corresponding to the video bitstream file, the video meta file, and the audio bitstream file.

20. The method of claim 19 further comprising:
generating an audio header file corresponding to the audio bitstream file;
generating a video header file corresponding to the video meta file;
merging the video bitstream file and the audio bitstream file into an AV bitstream file;
merging the audio header file and the video header file into an AV header file; and
merging the AV bitstream file and the AV header file into the media file.

21. A device, comprising:
a video encoder to runtime generate a video bitstream file and a video meta file during recording;
an audio encoder to runtime generate an audio bitstream file during recording; and
a processing unit to generate a media file corresponding to the video bitstream file, the video meta file, and the audio bitstream file after the recording is suspended.

22. The device of claim 23 wherein the processing unit further generates an audio header file corresponding to the audio bitstream file, generates a video header file corresponding to the video meta file, merges the video bitstream file and the audio bitstream file into an AV bitstream file, merges the audio header file and the video header file into an AV header file, and merges the AV bitstream file and the AV header file into the media file.

23. The device of claim 21 wherein the processing unit further generates a video header file corresponding to the video meta file, determines whether audio is recorded corresponding to the audio bitstream file, and merges the video bitstream file and the video header file into the media file if audio is not recorded.

24. The device of claim 21 wherein the video encoder further generates the video meta file by recording a video type, an average frame rate, a video time scale, a position recoding the bitstream size in a video file, VOS (Visual Object Sequence) information, a frame time stamp per video frame, and a frame length pet video frame therein.

25. A device, comprising:
a storage device; and
a processing unit to determine whether at least a video bitstream file and a video meta file exist in the storage device, determine whether the file sizes of the video bitstream file and the video meta file conform to the file sizes originally recorded if the video bitstream file and the video meta file exist, determine whether the video bitstream file and the video meta file have sufficient information to generate a media file if the file sizes conform, and generate the media file corresponding to the video bitstream file and the video meta file.

26. The device of claim 25 wherein the processing unit further corrects the video bitstream file or the video meta file if the file sizes do not conform.

27. The device of claim 26 wherein the processing unit further performs disk check if the correction for the video bitstream file or the video meta file fails.

28. The device of claim 25 wherein the processing unit further determines whether a register file recording storage paths for the video bitstream file and the video meta file exists in the storage device, and deletes all files in the storage device if the register file does not exist.

29. The device of claim 25 wherein the processing unit further determines whether a video header file, an audio header file, or an audio bitstream file exists in the storage device, and determines whether the file size of any existed file conforms.

30. The device of claim 25 wherein the processing unit further determines whether the video bitstream file and the video meta file have sufficient information to generate the media file by determining whether the size of the video bitstream file exceeds a specification defined value, and whether the size of the video meta file exceeds pre-stored necessary data.

31. The device of claim 25 wherein the processing unit further determines whether the video bitstream file and the video meta file have sufficient information to generate the media file by determining whether the total video frame number exceeds one.

32. The device of claim 25 wherein the processing unit fiber generates a video header file corresponding to the video meta file, and merges the video bitstream file and the video header file into the media file.

33. The device of claim 29 wherein the processing unit further generates a video header file corresponding to the video meta file, generates an audio header file corresponding to the audio bitstream file if the audio bitstream file exists, merges the video bitstream file and the audio bitstream file into an AV bitstream file, merges the audio header file and the video header file into an AV header file, and merges the AV bitstream file and the AV header file into the media file.

34. The device of claim 33 wherein the processing unit further generates the video header file by transforming a video type, an average frame rate, a video time scale, a position recoding the bitstream size in a video file, VOS (Visual Object Sequence) information, a frame time stamp per video frame, and a frame length per video frame recorded in the video meta file to a format of a media file specification.

35. A device, comprising:
a storage device; and
a processing unit to determine whether at least a video bitstream file and a video meta file exist in the storage device, and generate the media file corresponding to the video bitstream file and the video meta file.

36. The device of claim 35 wherein the processing unit further determines whether an audio bitstream file exists in the storage device, and generates the media file corresponding to the video bitstream file, the video meta file, and the audio bitstream file.

37. The device of claim 36 wherein the processing unit further generates an audio header file corresponding to the audio bitstream file, generates a video header file corresponding to the video meta file, merges the video bitstream file and the audio bitstream file into an AV bitstream file, merges the audio header file and the video header file into an AV header file, and merges the AV bitstream file and the AV header file into the media file.

38. A device, comprising:
means for runtime generating a video bitstream file and a video meta file during recording;
means for runtime generating an audio bitstream file during recording; and
means for generating a media file corresponding to the video bitstream file, the video meta file, and the audio bitstream file after the recording is suspended.

39. A device, comprising:
means for determining whether at least a video bitstream file and a video meta file exist in a storage device;
means for determining whether the file sizes of the video bitstream file and the video meta file conform to the file sizes originally recorded if the video bitstream file and the video meta file exist;
means for determining whether the video bitstream file and the video meta file have sufficient information to generate a media file if the file sizes conform; and
means for generating the media file corresponding to the video bitstream file and the video meta file.

40. A device, comprising:
means for determining whether at least a video bitstream file and a video meta file exist; and
means for generating the media file corresponding to the video bitstream file and the video meta file.
